(19) United States
(12) Patent Application Publication
(10) Pub. No.: US 2013/0097798 A1
(43) Pub. Date: Apr. 25, 2013

(54) CLEANING SYSTEM HAVING SELF-CHANGING CLEANING SURFACE

(71) Applicant: Julie Marie Francis, Lakeland, FL (US)

(72) Inventor: Julie Marie Francis, Lakeland, FL (US)

(21) Appl. No.: 13/444,687

(22) Filed: Apr. 11, 2012

Related U.S. Application Data
(60) Provisional application No. 61/516,938, filed on Apr. 11, 2011.

(51) Int. Cl. B08B 1/00

(52) U.S. Cl. CPC B08B 1/001
USPC 15/209.1

(57) ABSTRACT

A cleaning system having a handle attached to a cleaning head and a first roller disposed within the cleaning head, the first roller adapted to supply unused cleaning cloth is described. The cleaning system can also include a second roller disposed within the cleaning head and adapted to store used cleaning cloth. The cleaning system can further include a control section adapted to engage or disengage the first and second rollers in response to a control input so as to provide unused cleaning cloth from the first roller and to take up and store used cleaning cloth on the second roller.

This application claims the benefit of U.S. Provisional Application No. 61/516,938 filed Apr. 11, 2011 entitled “Device with Self-Changing Rolled Cleaning Cloth (Wet or Dry) for Floors and Other Flat Surfaces,” which is incorporated herein by reference in its entirety.

Embodiments relate generally to cleaning devices, and more particularly, to a cleaning system having a self changing cleaning surface.

Conventional disposal cleaning systems typically provide a single use cleaning pad for wet or dry mopping. When the cleaning pad has become soiled or used, it can be removed and discarded. A limitation with conventional systems may be that the soiled cleaning pad must be handled and that work is interrupted to change the cleaning pad.

Also, disposable single use cleaning pads found in conventional systems may limit the amount of cleaning that can be accomplished before a user stops and changes the cleaning pad.

Embodiments were conceived in light of the above-mentioned problems or limitations, among other things.

An embodiment includes a cleaning system having a handle attached to a cleaning head and a first roller disposed within the cleaning head, the first roller adapted to supply unused cleaning cloth is described. The cleaning system can also include a second roller disposed within the cleaning head and adapted to store used cleaning cloth. The cleaning system can further include a control section adapted to engage or disengage the first and second rollers in response to a control input so as to provide unused cleaning cloth from the first roller and to take up and store used cleaning cloth on the second roller.

### BRIEF DESCRIPTION OF THE DRAWINGS

FIG. 1 shows a cutaway view of an example cleaning system in accordance with at least one embodiment.

FIG. 2 is a diagram of the underside of an example cleaning system in accordance with at least one embodiment.

FIG. 3 is a diagram of a cleaning system in accordance with at least one embodiment.

FIG. 4 is a diagram showing handle detail of an example cleaning system in accordance with at least one embodiment.

FIG. 5 is a diagram of an example hand-held cleaning system in accordance with at least one embodiment.

FIG. 6 is a diagram of an example cleaning fluid supply bottle in accordance with at least one embodiment.

FIGS. 7A and 7B show an example retractable cleaning fluid nozzle system in accordance with at least one embodiment.

FIG. 8 shows an example recessed cleaning fluid nozzle system in accordance with at least one embodiment.

### DETAILED DESCRIPTION

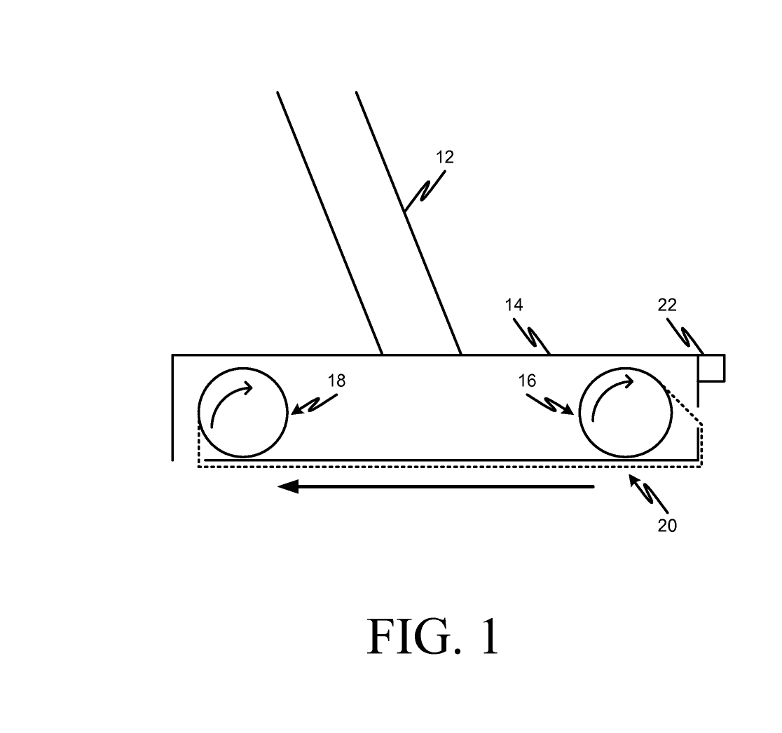

FIG. 1 shows an example cleaning system 10 having a handle 12 and a cleaning head 14. Within the cleaning head 14, there is a clean roller 16 and a used roller 18. A cleaning cloth 20 can be supplied from the clean roller 16 to the used roller 18. Also shown in the cleaning system 10, is an optional spray nozzle 22 for spraying cleaning fluid on a surface to be cleaned, for example.

In operation, the cleaning system 10 is used to clean surfaces such as floors, walls, windows or the like. The cleaning system 10 can include a cleaning and/or cleaning fluid adapted for cleaning a particular type of surface, such as wood, tile, vinyl, stone, metal, synthetics or the like. As the cleaning system 10 is being used, an exposed portion of cleaning cloth 20 may become soiled. In order to provide a fresh cleaning cloth surface to continue cleaning, unused cleaning cloth material can be fed from clean roller 16 while the used cleaning cloth material can be taken up on used roller 18, thereby providing a fresh surface exposed for continued cleaning below the cleaning head 14. It will be appreciated that although the term cleaning cloth is used herein, the cleaning cloth can be made of any suitable material such as cloth, paper, natural fiber, synthetic fiber or the like.

The cleaning cloth 20 is supplied by roller 16 and travels out the front of the cleaning head 14 and wraps around the front bottom corner of the cleaning head. This configuration provides a corner edge over which the cleaning cloth 20 is stretched so that the cleaning system can reach corners. Also, a relatively firm, flat supportive surface is provided underneath the cleaning head 14 to cause the cleaning cloth 20 to be pressed against a work surface as the cleaning system is being used.

As the cleaning cloth is fed from the clean roller, used to clean a work surface, then rolled onto the used roller, the supply of fresh cleaning cloth 20 supplied by roller 16 will eventually be exhausted. The cleaning cloth can be attached to a piece of plastic film (or other water resistant material) that is wound onto the clean roller first followed by the cleaning cloth such that, when the last cleaning cloth is unwound from the clean supply roller 16, the plastic film beings to unwind from the clean supply roller 16. There can be enough plastic film material supplied so that the plastic film can be wound around the used roller 18 and can cover the soiled cleaning cloth 20 that was previously wound around the used roller 18. Thus, when handling the used roller, a user does not have to touch soiled cleaning cloth, but rather can contact only the plastic film.

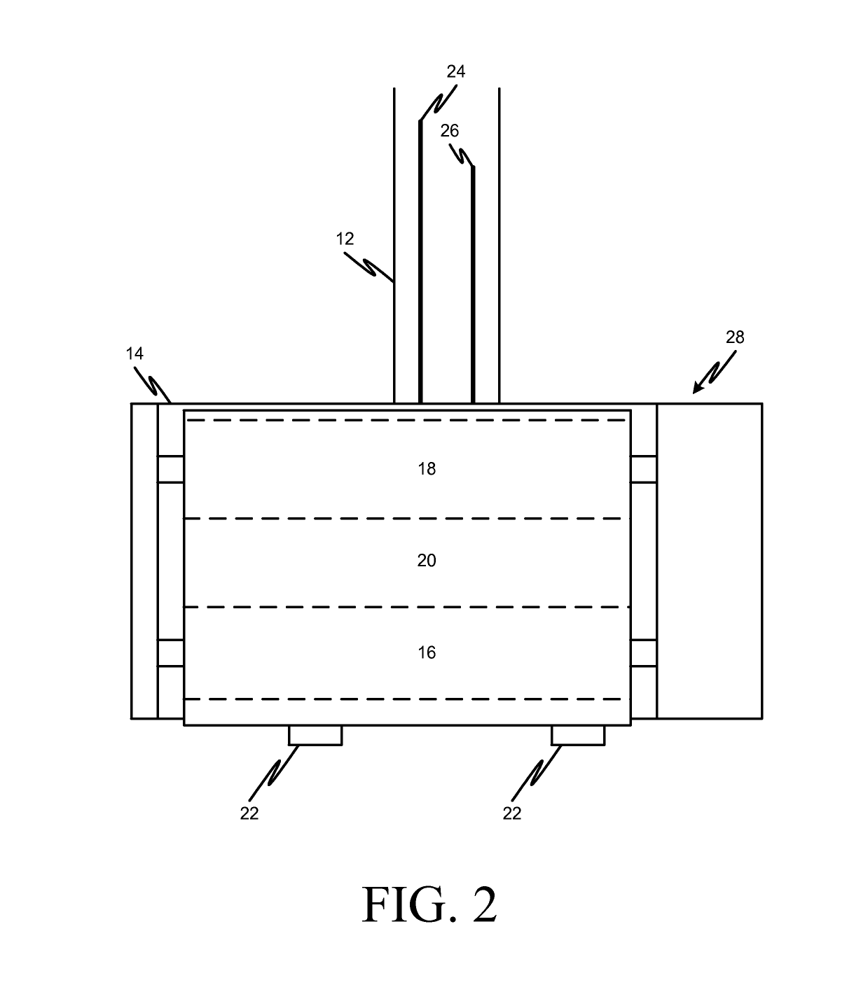

FIG. 2 shows a diagram of the underside of the cleaning head 14. In particular, the cleaning cloth or material 20 is shown spanning the clean supply roller 16 and a used roller 18 (both rollers shown in dashed lines).

A cleaning fluid line 24 and a control cable or line 26 extend from the handle 12 into the cleaning head 14. The cleaning fluid line 24 supplies cleaning fluid to the cleaning head 14 and, in particular, to the nozzles 22. The control cable or line 26 is used to activate the self-feeding mechanism that provides a clean, fresh cloth or pad surface. The control cable 26 connects to a control mechanism 28. The control mechanism 28 in conjunction with the control cable 26 allows the clean roller 16 and the used roller 18 to rotate when a user has activated a control on the handle 12. For example, a user may activate a control on the handle 12 that is connected to control cable 26 in order to cause the clean roller and the used roller to rotate. As the clean roller rotates, it provides a fresh cleaning surface and the used or soiled portion of the cleaning pad or cloth is taken up on used roller 18.

It will be appreciated that the cleaning fluid and/or control lines can be mechanical and/or electrical and that the cleaning fluid spraying and self-changing of the cleaning cloth can be carried out by a manual, mechanical apparatus, by an automatic electro-mechanical apparatus or by a combination of the above.

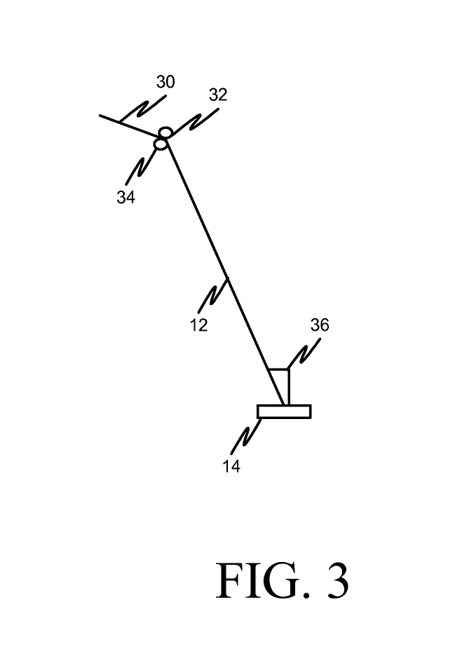

FIG. 3 shows a diagram of an example cleaning system in accordance with at least one embodiment. The cleaning system has a handle 12 and a cleaning head 14. Also shown are a grip portion 30 and a first control 32 and a second control 34. The first control 32 can be used to control the self-feeding mechanism and the second control 34 can be used to control dispensing of cleaning fluid which can be provided by cleaning fluid tank 36.

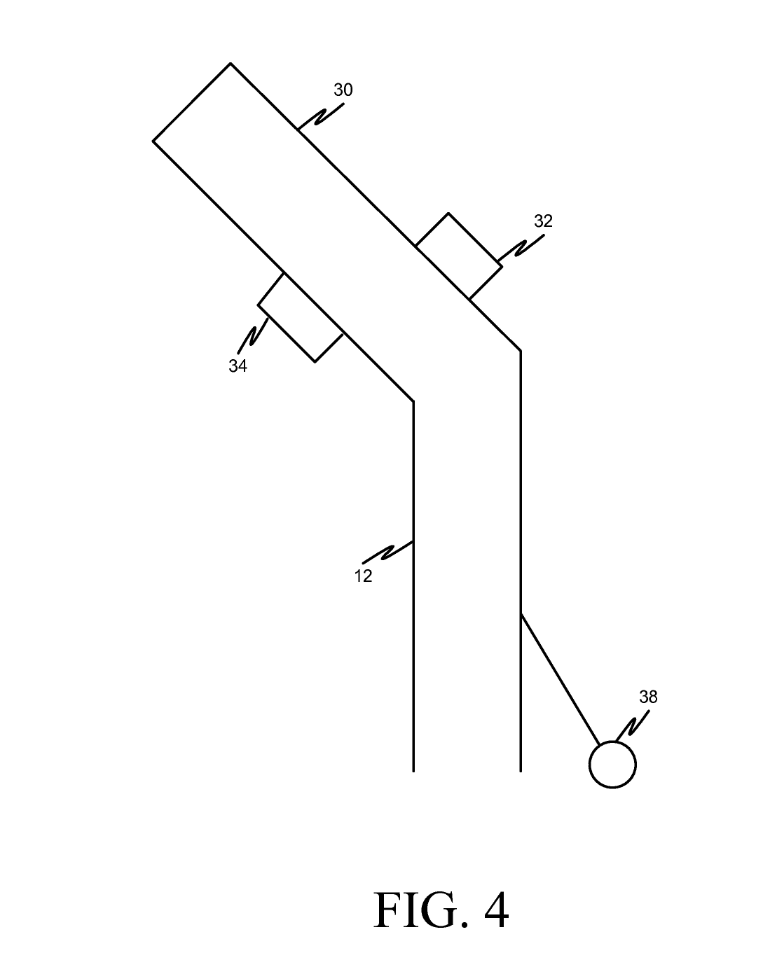

FIG. 4 shows the handle of a cleaning system in greater detail. In particular, the handle 12 includes a hand grip portion 30, a first control 32 and a second control 34 as described above. In addition to or as an alternative to the controls 32 and/or 34, a manual mechanical control 38 is shown disposed on the body of the handle 12. The control 38 can be used to activate the self feeding mechanism described above within the cleaning head 14.

The controls (e.g., 32, 34 and/or 38) can be placed anywhere on the handle according to a contemplated design. Also, the control for applying cleaning fluid can be an electrical switch that activates a pump/pressure system or it can be a mechanical control such as a squeeze pump or bulb that causes cleaning fluid to be pumped from the cleaning fluid supply and sprayed from the nozzles.

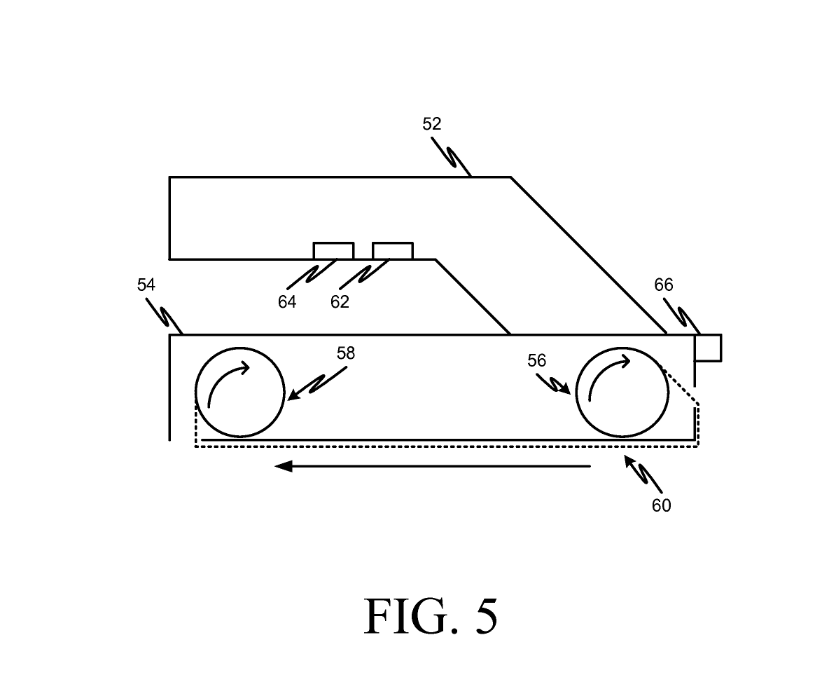

FIG. 5 shows a hand-held embodiment of a cleaning system 50. The cleaning system includes a handle 52, a cleaning head 54, a clean supply roller 56, a cleaning pad or cloth material 60, a used roller 58, a first control 62 and a second control 64. In operation, the hand-held cleaning system 50 can be used to clean surfaces. When it is desired that a clean, fresh pad or cloth material be provided, a control 62 can be activated that allows clean cloth or pad material to be supplied from clean roller 56 and used or soiled cloth or pad material to be taken up by used roller 58, thereby providing a clean surface of the cloth or pad material 60 to continue cleaning.

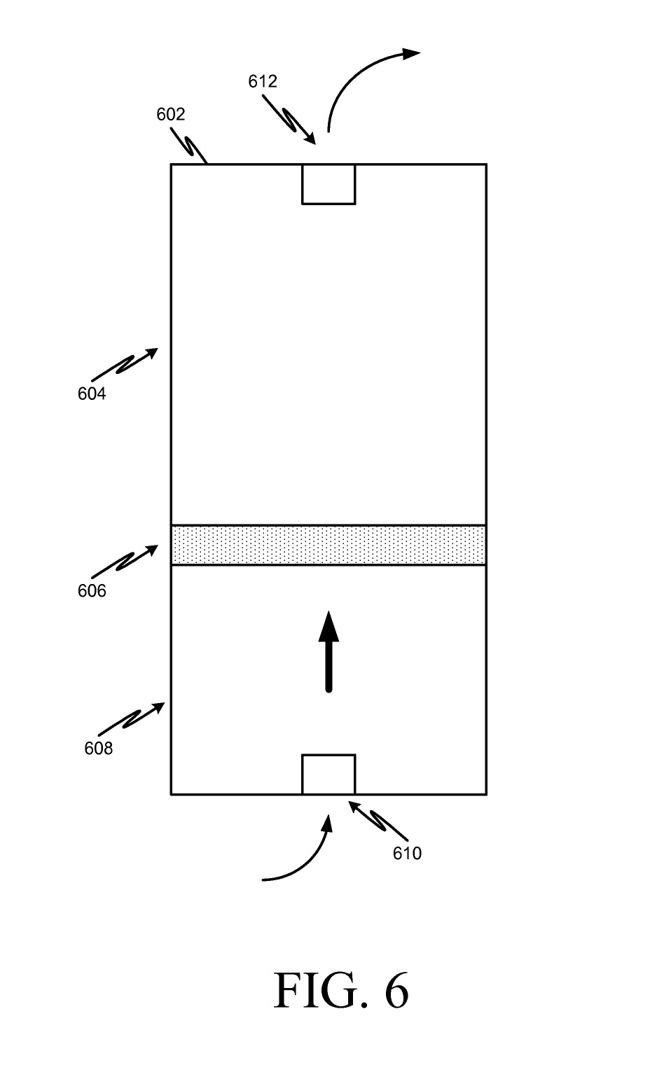

As shown in FIG. 6, a cleaning fluid supply bottle 602 includes a fluid containing portion 604, a movable partition 606 and a pressurized portion 608. The bottle 602 also includes a pressure inlet 610 and a fluid outlet 612.

In operation, air (or fluid) pressure is applied to the inlet 610, which causes the movable partition 606 to move toward the fluid containing portion 604. As a result, pressure in the fluid containing portion 604 increases causing cleaning fluid to be discharged from the outlet 612. The cleaning fluid can then travel through a fluid supply line and be sprayed from one or more nozzles onto a work surface to be cleaned.

By using pressure to cause the cleaning fluid to be discharged from the bottle 602, the cleaning system can be used in any orientation (e.g., held up right vertically to clean windows) without depending on gravity to feed the cleaning fluid to the supply line.

The movable partition 606 can be a pliable partition made of plastic, rubber or the like. The bottle 602 can be removed from the cleaning system and refilled with cleaning fluid. Alternatively, the bottle can be a disposable bottle.

The bottle can also include a flexible membrane that contains the cleaning fluid, similar to the membranes (or liners) used in some baby bottles. The flexible membrane can collapse as the cleaning fluid is used.

The inlet 610 and outlet 612 can be configured to connect with respective counterparts on the cleaning system. The bottle 602 can also include a releasable connection or latching mechanism to engage the bottle 602 and secure it to the cleaning system when in use.

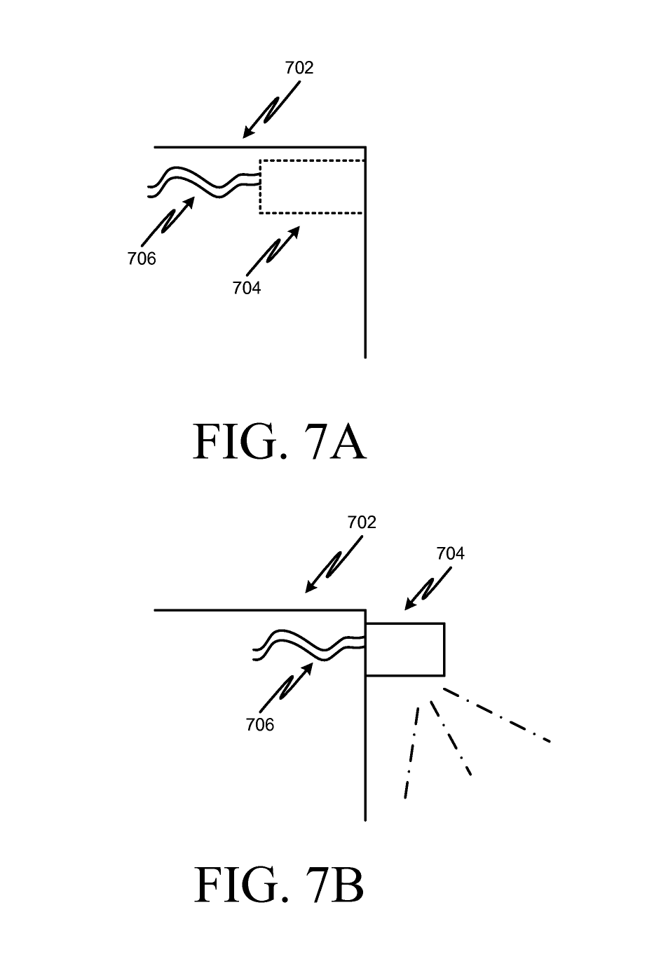

FIGS. 7A and 7B show a cleaning head having a retractable cleaning fluid nozzle 704 coupled to a cleaning fluid supply line 706. When cleaning fluid is not being applied, the nozzle 704 can be in a retracted position (as shown in FIG. 7A). When cleaning fluid is being applied, the nozzle 704 can extend as shown in FIG. 7B. By providing a retractable nozzle system, the cleaning head can clean against a wall or other surface without a nozzle on the front of the cleaning head protruding and interfering. The retractable nozzle 704 can be biased in a retracted position by a spring (not shown) or the like, and can extend under force of cleaning fluid pressure or by other mechanical or electromechanical components.

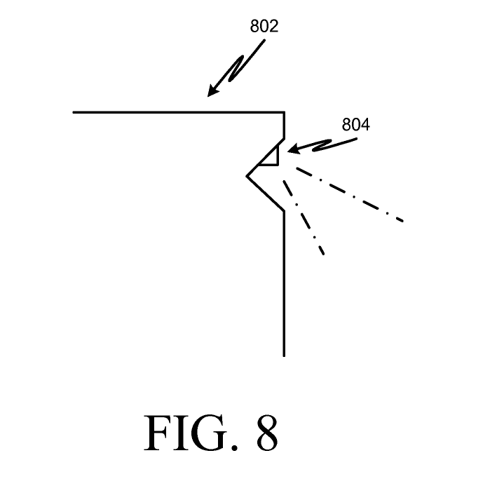

FIG. 8 shows a diagram of a cleaning head 802 having a recessed nozzle 804 that is fixed in place. The recessed nozzle 804 can apply cleaning fluid, while not interfering with the front of the cleaning head contacting a surface such as a wall.

It is, therefore, apparent that there is provided, in accordance with the various embodiments disclosed herein, cleaning systems having a self-changing cleaning surface.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A cleaning system comprising:
a handle attached to a cleaning head;
a first roller disposed within the cleaning head, the first roller adapted to supply unused cleaning cloth;
a second roller disposed within the cleaning head and adapted to store used cleaning cloth; and
a control section adapted to engage or disengage the first and second rollers in response to a control input so as to provide unused cleaning cloth from the first roller and to take up and store used cleaning cloth on the second roller.

2. The cleaning system of claim 1, wherein the control section includes a mechanism adapted to lock or unlock the first and second rollers to permit the rollers to roll in an unlocked position and to prevent the rollers from rolling in a locked position.

3. The cleaning system of claim 1, further comprising a cleaning fluid supply tank, a cleaning fluid supply line, and one or more cleaning fluid nozzles, wherein the cleaning fluid supply tank is disposed on the handle of the cleaning system and the one or more cleaning fluid nozzles are disposed on the cleaning head.

4. The cleaning system of claim 1, wherein the first and second rollers are housed in a removable cartridge.

5. The cleaning system of claim 1, wherein the first roller and the second roller are each independently removable from the cleaning head.

6. The cleaning system of claim 1, wherein the cleaning cloth is a disposable material.

7. The cleaning system of claim 1, wherein the cleaning cloth is a reusable material.

8. The cleaning system of claim 1, wherein the first and second rollers are disposable.

9. A hand-held cleaning system comprising:
a handle;
a cleaning head attached to the handle;
a first roller disposed within the cleaning head;
a second roller disposed within the cleaning head; and
one or more controls disposed on the handle, wherein a cleaning cloth is supplied from the first roller to the second roller in response to a control input received from the one or more controls.

10. The cleaning system of claim 9, further comprising a control section that includes a mechanism adapted to permit the rollers to roll in response to the control input.

11. The cleaning system of claim 9, further comprising a cleaning fluid supply tank, a cleaning fluid supply line, and one or more cleaning fluid nozzles, wherein the cleaning fluid supply tank is disposed on the handle of the cleaning system and the one or more cleaning fluid nozzles are disposed on the cleaning head.

12. The cleaning system of claim 9, wherein the first and second rollers are housed in a removable cartridge.

13. The cleaning system of claim 9, wherein the first roller and the second roller are each independently removable from the cleaning head.

14. The cleaning system of claim 9, wherein the cleaning cloth is a disposable material.

15. The cleaning system of claim 9, wherein the cleaning cloth is a reusable material.

16. The cleaning system of claim 9, wherein the first and second rollers are disposable.

17. The cleaning system of claim 11, wherein cleaning fluid is supplied in response to one of a manually exerted force or an automatically exerted force.
